(19) United States
(12) Patent Application Publication
(10) Pub. No.: US 2026/0359990 A1
(43) Pub. Date: Nov. 12, 2026

(54) METHOD FOR AUTOMATICALLY SEGMENTING AN ORGAN ON A THREE-DIMENSIONAL MEDICAL IMAGE

(71) Applicant: KOELIS, Meylan (FR)

(72) Inventors: Paul WEGIEL, Claix (FR); Eric GAUDARD SURLIUGA, Lyon (FR); Michael BAUMANN, La Tronche (FR); Antoine LEROY, Bois D'arcy (FR)

(73) Assignee: KOELIS, Meylan (FR)

(21) Appl. No.: 19/123,903

(22) PCT Filed: Nov. 20, 2023
(86) PCT No.: PCT/EP2023/082439

§ 371 Date: Apr. 24, 2025

(30) Foreign Application Priority Data
Nov. 21, 2022 (FR) FR2212085

(51) Int. Cl. G06T 7/149; G06T 7/12

(52) U.S. Cl. CPC G06T 7/149; G06T 7/12; G06T 2207/20084; G06T 2207/30004

(57) ABSTRACT

A method for segmenting a three-dimensional image of at least one organ of a patient, including at least the steps of extracting from the three-dimensional image of the organ a probability map which assigns to each voxel of the image a probability of belonging to a contour of the organ on the image; extracting from the probability map at least one target point based on the probability of belonging to the contour of the organ on the image, each target point being extracted from the probability map by applying to the probability map at least one threshold for the probability of belonging to the contour of the organ on the image; and, based on each target point extracted in the preceding step, deforming a deformable model of this organ in order to obtain the three-dimensional segmentation of the organ on the image.

The present invention relates to the field of medical imaging for, e.g., diagnostic purposes (such as disease screening), treatment purposes (such as guiding surgical instruments), etc. The invention relates more particularly to the segmentation of an organ on three-dimensional medical images, i.e., the determination of the contour of the organ in such an image.

### BACKGROUND OF THE INVENTION

Several technologies exist for obtaining three-dimensional images of a patient's organ. One of the most widely used is ultrasound, that allows images to be obtained quickly, possibly pre-operatively, using relatively inexpensive equipment compared to other technologies, such as magnetic resonance imaging or MRI.

Once the image is obtained, it may be useful for the practitioner to identify the contour of the organ to be analysed. This is particularly the case if the contour of the organ is subsequently required to plan an operative procedure, or to merge different images together. This operation of identifying the contour may be performed manually, with tools making it possible to design the contour of the organ directly on the image. This, however, is time-consuming, daunting, and fails to meet two essential requirements: high accuracy and high reproducibility.

Image segmentation algorithms are known which use image properties such as intensity discontinuities in the image (an Edge-Based Segmentation method based on gradients) or similarities between image elements (pixels for two-dimensional images, voxels for three-dimensional images; RegionBased Segmentation method). However, these algorithms are rarely effective over the entire contour of the organ present in the image.

Thus, in the case of ultrasound of the prostate, it is difficult to distinguish the contour of the organ from the surrounding tissues, in particular, for the lower part of the prostate, mainly because of the low contrast between the prostatic and non-prostatic zones, the granularity of the ultrasound images which may have black-spots and/or speckling and the short range of grey levels available.

### AIM OF THE INVENTION

A particular aim of the invention is to improve the segmentation of medical images.

### SUMMARY OF THE INVENTION

To this end, the invention provides a method for segmenting a three-dimensional image of at least one organ of a patient, comprising at least the following steps:
extracting from the three-dimensional image of the organ a probability map which assigns to each voxel of the image a probability of belonging to a contour of the organ on the image;
extracting from the probability map at least one target point based on the probability of belonging to the contour of the organ on the image, each target point being extracted from the probability map by applying to the probability map at least one threshold for the probability of belonging to the contour of the organ on the image;
and based on each target point extracted in the preceding step, deforming a deformable model of this organ in order to obtain the three-dimensional segmentation of the organ on the image.

The model is said to be deformable in that it may be applied to an image and deformed from at least one target point to correspond at any point to the contour of the organ being looked for in the image.

Thus, the first step is to search for at least one target point whose belonging to the contour of the organ present in the image has a probability considered as sufficient and the deformable model is applied to the image on the basis of this target point. Thus, the target points that are most likely to belong to the contour are considered accurate and the definition of the contour is completed on the basis of the anatomical data of the deformable model. Therefore, no account is taken of the least likely points to apply the deformable model, because this may introduce an error in the segmentation, by deforming the deformable model on the basis of target points whose probability of belonging to the contour of the organ would be too low, and therefore for which the risk that these points would not really belong to the contour of the organ would be too high. This combination significantly improves the segmentation obtained, particularly when the number of target points selected by the process is high.

In particular, this invention ensures that only the highest probability values are used to determine the target points. In this way, by using the invention, the most questionable zones belonging to an organ are removed from the probability map instead of trying to adjust them.

The probability map is three-dimensional.

The probability map is not only defined by two unique values, one of which would represent the belonging to the organ contour and the other would represent the absence of belonging to the organ contour.

Usually, more than a single target point is extracted from the probability map. Usually, a cluster of target points is thus extracted from the probability map.

It may thus be understood that the threshold makes it possible to discard all of the voxels of the image for which the probability of belonging to the contour of the organ is too low.

Optionally, the probability map is extracted by means of a model distinct from the deformable model.

Optionally, the distinct model is defined by an at least partially-automatic segmentation method.

Optionally, this distinct model is defined by at least one artificial intelligence (or neural network) trained on the basis of segmented images of the organ of at least other people.

Optionally, the at least one threshold is general.

Optionally, the at least one threshold is local.

Optionally, the at least one threshold has a value independent of the organ and/or the patient and/or the three-dimensional image and/or the probability map.

Optionally, the at least one threshold has a value dependent on the organ and/or the patient and/or the three-dimensional image and/or the probability map.

Optionally the at least one threshold is dynamic.

Optionally, the at least one dynamic threshold is a local threshold making it possible to select only local probability maxima of the probability map.

Optionally, the value of the at least one threshold may be manually modulated.

Optionally, the probability map is extracted by means of a model that is distinct from the deformable model, and in which the value of said at least one threshold may be modulated automatically if at least one characteristic of the three-dimensional image in question differs from those of the images which the distinct model was designed from.

Optionally, the deformable model is a statistical model describing the shape of the organ to be segmented.

A statistical shape model is a model that, as its name indicates, is defined on the basis of different shapes of the organ in question according to the frequency of these shapes throughout the population.

Optionally, the deformable model is initially defined on the basis of the average of the shapes of the same organ in question but of other patients than the patient in question.

Optionally, the initial shape of the deformable model is determined by an imaging technology other than ultrasound.

Optionally, the deformable model has an initial shape combined with a segmentation of the same organ in question of the same patient, obtained from an image acquired prior to acquiring the image currently being segmented.

Optionally, the segmentation obtained during a previous examination is determined by an imaging technology other than ultrasound.

Optionally, at least one target point may be added manually to said at least one target point extracted from the probability map.

Optionally, if the number of target points is lower than a pre-determined threshold, the method is interrupted.

Optionally, in the event of interruption(s), the probability map is abandoned and the deformable model is deformed on the basis of manually-added target points.

Optionally, the deformable model is firstly pre-deformed. Optionally, the deformable model is pre-deformed by being pre-aligned generally to the target points. Optionally, the deformable model is deformed based on only some of the target points used in the pre-deformation step. Optionally:
from each target point extracted from the probability map, the deformable model is pre-deformed;
then only some of the target points extracted from the probability map are selected to form a sub-group of target points having a higher probability of belonging to the contour of the organ on the image than the target points not belonging to the sub-group;
from each target point of the sub-group, the deformable model is deformed.

Optionally, the deformable model is deformed by means of an iterative approach. Optionally, at each iteration, each target point is matched with the closest deformable model point. Optionally, at each iteration, the deformed model is firstly generally deformed via an affine transformation (and/or scaled) and then locally deformed. Optionally, the deformation of the deformable model is performed iteratively by alternating at least a scaling phase with an elastic deformation phase. Optionally, during the scaling phase, a general deformation is also performed, and in which at each iteration, an elastic deformation field resulting from the elastic deformation is broken down into an affine component and a non-linear residual deformation, the affine component being used for the general deformation during the next iteration. Optionally, the iterations are stopped when the distances between the target points and corresponding points of the deformable model are lower than a pre-determined threshold.

Optionally, the quality of the segmentation obtained is estimated. Optionally, the quality of the segmentation obtained is estimated, by evaluating a spatial correlation between the probability map and said segmentation.

The invention also relates to an installation comprising at least one image acquisition device and means for segmenting at least one image acquired by said device according to the method, as specified above.

The invention also relates to a computer program comprising instructions which lead an installation as specified above to perform the method as specified above.

The invention also relates to a computer readable storage medium on which the computer program is recorded, as specified above.

Other characteristics and advantages of the invention appear on reading the following description of particular, non-limiting implementations of the invention.

### BRIEF DESCRIPTION OF THE DRAWING

Reference is made to the accompanying drawings, among which:

FIG. 1 is a flow chart of a first implementation of the method of the invention;

FIG. 2 is a flow chart illustrating of a second implementation of the method of the invention;

FIG. 3 is a view of an ultrasound image of a prostate, on which, target points are being looked for;

FIG. 4 is a view of the same ultrasound image on which target points have been selected;

FIG. 5 is a view of the same ultrasound image on which a contour has been plotted;

FIG. 6 is a diagrammatic view of an ultrasound device for implementing the method of the invention.

### DETAILED DESCRIPTION OF THE INVENTION

In this case, the invention is described in application to the segmentation of an ultrasound image of a patient's prostate. However, the invention is applicable to the image of any organ and/or any patient (animal or human) and/or to any technology of an image acquisition of such an organ.

The invention is a method for segmenting a three-dimensional image. In the figures, for simplicity reasons, the images shown are two-dimensional images.

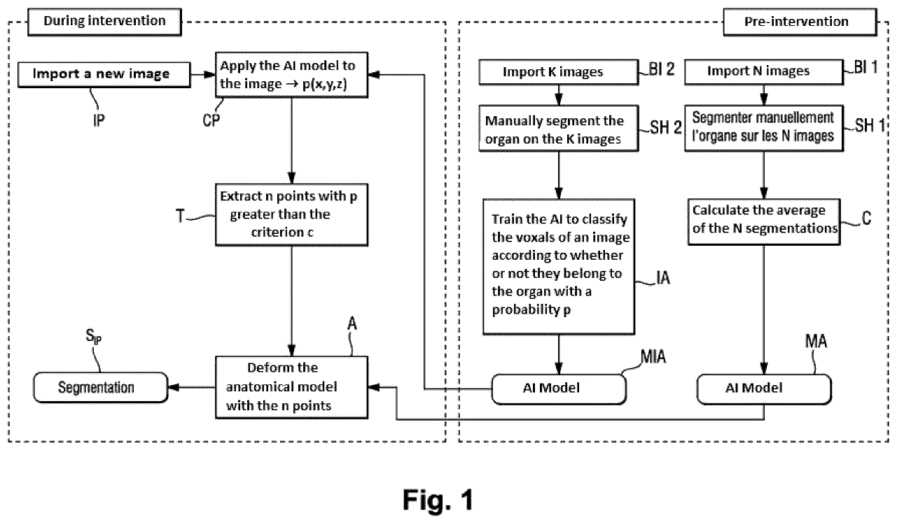

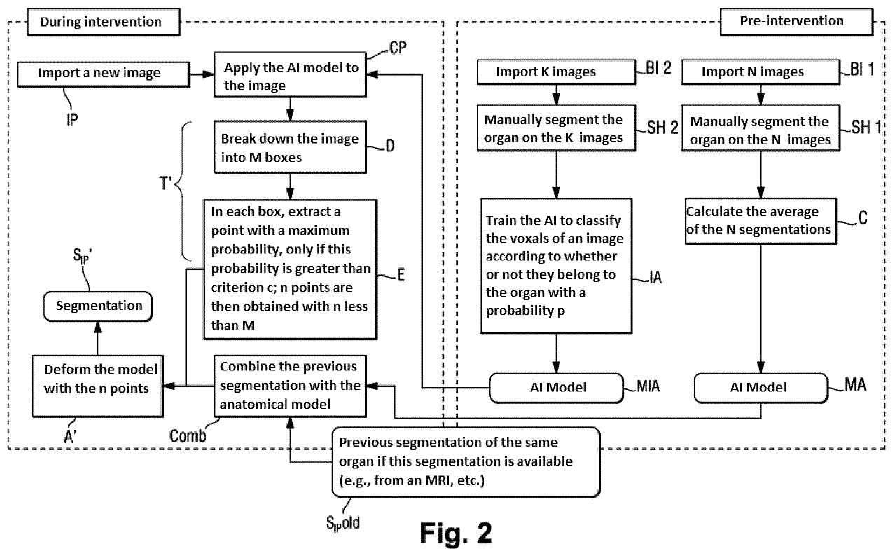

With reference to FIGS. 1 and 2, in the two implementations described in this case, the segmentation method is based on an Anatomical Model MA and an Artificial Intelligence Model MIA.

The Anatomical Model MA is developed from at least one image bank BI₁ comprising N images of the prostate. The N images are optionally images acquired with a different technology from that used for acquiring the images which will have to be segmented subsequently and, for example, by an MRI technology.

Each image N is then segmented. For example, segmentation is performed manually during human segmentation SH₁. Optionally, this segmentation may be performed by a practitioner or another qualified person. These segmentations are then processed by computer (C) to calculate an average of the said segmentations (referred to subsequently as MS the average shape) and to deduce the Anatomical Model MA. The Anatomical Model MA is a statistical model that can be deformed and is obtained by a statistical study of the average shape of the prostate and any possible variations. It should be noted that the design of an anatomical model is known per se and, in this case, will not be described further.

The Artificial Intelligence Model MIA is developed from at least one image bank BI₂ comprising K images of the prostate. The image bank BI₂ is optionally different from the image bank BI₁ used to make the Anatomical Model MA.

Each image K is then segmented. For example, segmentation is performed manually during human segmentation SH₂. Optionally, this segmentation may be performed by a practitioner or another qualified person.

Preferably, the Artificial Intelligence Model MIA is developed from segmented images whose imaging modality corresponds to that of the images which are required to be segmented subsequently. Thus, the images in this case K are one captured by using the same technology as that used for acquiring the images which will have to be segmented subsequently, in this case, ultrasound.

These segmentations resulting from SH₂ lead an artificial intelligence IA to train it to estimate for each voxel of a given image the probability that this voxel belongs to the contour of the prostate present in said image. The artificial intelligence model is obtained from this MIA. It should be noted that the design and training of an artificial intelligence to obtain an artificial intelligence model are known per se and will not be described further, in this case. To this end, the artificial intelligence model may be obtained by means of machine learning and, for example, may be obtained by means of a neural network and, for example, by means of deep learning.

### First Implementation

To segment an image of the prostate of a patient by means of the method according to the first embodiment shown in FIG. 1, it is necessary to acquire an image IP of the prostate of the patient, transmit the image IP to a computer system applying the Artificial Intelligence Model MIA to the image IP received as input. It will be understood that the neural network may be implemented on the same computer system or on a different system.

A prediction is thus obtained at the output, in the form of a three-dimensional CP probability map in which each position voxel x, y, z in the image is assigned a probability p(x,y,z) of belonging to the contour of the prostate in the image IP. The probability map image CP is a three-dimensional image.

Advantageously, the probability of belonging has a value V that lies between two limits of a closed interval (for example, between 0 and 1 or between 0 and 100). The probability map CP is thus accurate because it is defined both by binary values 0 or 1 and by a range of values V all between two limits of a closed interval.

This probability map CP may optionally be presented to an operator. Optionally, the probability of belonging may be symbolised by a colour code to simplify the operator's understanding. For example, the higher the probability of belonging to the prostate, the warmer and more similar its colour, and the lower the probability of belonging to the prostate, the colder the colour. A zero probability of belonging to the prostate is thus symbolised by giving the associated voxel the colour black and a certain probability of belonging to the prostate is thus symbolised by giving the associated voxel the colour red. Given that certain voxels of the probability map CP may have a zero probability of belonging to the prostate (in particular, the voxels internal to the prostate, remembering that, in this case, all of the voxels of the image IP are involved in the first segmentation step), this may cause the probability map CP not to have entirely closed contours.

After having defined a general c threshold for the probability of belonging (this general threshold c being pre-defined), corresponding to an acceptable probability of belonging, the computer system executes an algorithm for filtering the voxels of the probability map to select, during a selection operation T, n target points each corresponding to a position voxel x, y, z having a probability p(x,y,z) greater than the general threshold c.

The threshold c is said to be general because it is applied in the same way and with the same value for all voxels.

Optionally, the threshold c is fixed, unlike a dynamic threshold whose value would be adapted to the probability map CP and/or to the image in question IP.

This threshold thus c makes it possible to discard all voxels for which the probability of belonging to the contour is too low.

Therefore, the threshold value c is set for the intended application and the Artificial Intelligence Model MIA used at an optimised value. Preferably, the threshold value will be modified c according to the intended application and the Artificial Intelligence Model MIA used in order to set it to a new optimised value. The value of the threshold c may, in particular, be determined by a compromise between the required precision and sensitivity of the model, established via the analysis of sensitivity-precision curves or ROC curves.

The selection operation T is thus a filtering operation on the probability map CP. As a result, only target points with a very high probability of belonging to the contour of the prostate in the image are retained IP.

It may thus be understood that the target points are three-dimensional.

It may also be understood that at the end of the selection operation T, a cluster of target points is obtained.

Depending on the image IP, the number of target points thus extracted may be high. Therefore, at the end of the selection operation T, certain groups of target points may already locally design contours of a prostate (in the form of at least one continuous surface and/or at least one discontinuous surface formed by points). Nevertheless, since other voxels on the probability map CP have been discarded (because their probability p(x,y,z) of belonging to the prostate in the image IP was too low and below the threshold c), these contours are necessarily partial. Under no circumstances, at the end of the selection operation T, is a representation obtained of a prostate whose contours would be entirely closed. During a deformation operation A, the Anatomical Model MA is applied to the image IP by deforming the Anatomical Model MA on the basis of the n target points retained at the end of the operation T. It is understood that the anatomical model MA thus makes it possible to determine the contour of the prostate on the image to be segmented based on the n target points.

For example, the Anatomical Model MA designs one or more continuous surfaces between target points adjacent to one another (by interpolating and/or connecting them) and completes said surfaces to design a closed contour of the prostate via the anatomical information that it contains.

The Anatomical Model MA deforms only on the basis of the target points.

The Anatomical Model thus MA makes it possible to close the partial contour(s) which were defined by the cluster of target points.

The deformation operation A may therefore be seen as a transformation step of the Anatomical Model MA on the previously-established cluster of target points.

The deformation of the Anatomical Model MA may be performed in a single phase or in several phases. For example, the Anatomical Model MA may be deformed by iteration. For example, at each iteration i:
each target point is matched with the point of MA the nearest Anatomical Model;
then the Anatomical Model MA is scaled (scaling means that the Anatomical Model MA as a whole is enlarged or narrowed to better correspond to the target points—this scaling being particularly interesting for a patient whose organ in question is of a much larger or much smaller size than the average and therefore for whom the organ in question is of a much larger or much smaller size than the Anatomical Model MA) and generally deformed via an affine transformation based on the distance between each target point in question and the point of the Anatomical Model MA that is matched to it (for example, the transformation is determined so as to minimise the sum of said distances and/or, for example, the transformation is calculated with the Arun algorithm);
then the Anatomical Model MA is elastically deformed, under the action of external forces deforming the Anatomical Model MA towards the target points and internal forces ensuring the regularity of the surface of the Anatomical Model MA (an elastic deformation being well known in the prior art, it will not be detailed further, it being understood that the external forces are obtained based on the distance between each target point in question and the point of the Anatomical Model MA that has matched it and the internal forces are obtained based on the Anatomical Model MA before deformation and/or on a constraint to have a smooth deformed contour, the deformation being based on the sum of these external and internal forces to deduce a movement of each of the vertices of the Anatomical Model MA).

Iterations i are stopped when the distances between the target points and the corresponding matched points of the Anatomical Model MA are, for all the target points, lower than a predetermined threshold.

This iterative approach, successively affine then elastic, allows the elastic deformations to gradually correct the errors of the previous affine transformation, and vice-versa.

An extrapolation of the contour from the Anatomical Model is thus performed MA.

This iterative approach is particularly interesting in places where the Anatomical Model MA is very far from a target point or a grouping of target points and/or in places where there are few target points.

This iterative approach makes it possible to generate an extrapolation of the contour of very good quality on the basis of the Anatomical Model MA even in places where the Anatomical Model MA is very far from a target point or a grouping of target points and/or in places where there are few target points.

The segmentation of the image S_{Ip} is then obtained IP.

Preferably, the deformation operation A takes into account at least one mesh coherence constraint during deformation of the Anatomical Model MA: preventing the creation of a fold in the mesh, applying an elastic deformation or fluid mechanics constraint optionally according to a biomechanical model of the organ during the propagation of the deformation, etc.

Optionally, at each iteration i and via Arun's algorithm, an affine transformation is extracted during the elastic deformation of the Anatomical Model MA. For example, the elastic deformation field used during the elastic deformation is broken down by using Arun's algorithm into an affine component and a non-linear residual deformation. It is then possible to use this affine component to scale said model during the next iteration i+1. This allows for consistent general deformation during i+1 iteration even in zones not covered by target points.

Optionally, at least one of the internal forces is defined on the basis of at least one statistical study on the shape of the prostate (study identical to or different from that which has led to the creation of the Anatomical Model MA). An internal force thus makes it possible to further limit the risk of obtaining an S_{Ip} anatomically improbable segmentation.

It is understood that even if the Anatomical Model MA is deformed from n target points, the Anatomical Model MA may pass through only a portion of the n target points.

It is possible to refine the selection of target points by using a double filtering algorithm. Such double filtering is explained in relation to the second embodiment below, but may also be used with the first embodiment.

An example of a device that may be used to examine a patient in the context of the method of the invention may be seen in FIG. 6. This is ultrasound device 10 comprising a housing 11 containing a computer system 12 connected to an ultrasound probe 13, to a screen 14 and to a computer network R. The computer system 12 is a computer that comprises at least one processor and a memory. In this case, the memory comprises models MIA and MA and a computer program comprising instructions arranged to implement the method of the invention.

Optionally the computer program has instructions arranged to implement the neural network itself implementing the artificial intelligence model MIA.

The ultrasound probe 13 allows the acquisition of the images IP which will be processed by the computer system 12 and displayed on the screen 14. The R network is used to connect to a server containing, for example, reports, images of examinations of patients for which either the practitioner is responsible or the body in which the practitioner practices is responsible, etc.

### Second Implementation

In the second embodiment shown in FIG. 2, the Artificial Intelligence Model MIA and the Anatomical Model are available MA. In addition, an older segmentation

$${S}_{IP}^{old}$$

is available, of the patient's prostate that is being examined (by old, it is meant that it was performed during a previous examination). During a combining operation Comb, the Anatomical Model MA is combined with the older p segmentation

$${S}_{IP}^{old} ,$$

for example by replacing the average shape MS contained in the MA by this segmentation

$${S}_{IP}^{old} .$$

Naturally, other possible combinations are possible: for example, performing an average of MS and this segmentation

$${S}_{IP}^{old}$$

or a weighted average of the average shape MS and this segmentation

$${S}_{IP}^{old} .$$

A Combined Anatomical Model is thus obtained MA′. It should be noted that the old segmentation

$${S}_{IP}^{old}$$

may be derived from an ultrasound image or obtained via another technology such as an MRI image.

As above, it starts by acquiring an image IP of the patient's prostate. As above, the image IP is transmitted to a computer system in order to apply the artificial intelligence model to the image IP received as input. This makes it possible to obtain a prediction at the output in the form of a three-dimensional probability map CP in which each position voxel x, y, z in the image is assigned a probability p(x,y,z) of belonging to the contour of the prostate.

The probability map image CP is a three-dimensional image.

Advantageously, the probability of belonging has a value V that lies between two limits of an interval, the two limits being included (for example, between 0 and 1 or between 0 and 100). The probability map CP is thus accurate because it is defined both by binary values 0 or 1 and by a range of values V all between two limits of an interval, both limits being included.

This probability map CP may optionally be presented to an operator. Optionally, the probability of belonging may be symbolised by a colour code to simplify the operator's understanding. For example, the higher the probability of belonging to the prostate, the warmer and more similar its colour, and the lower the probability of belonging to the prostate, the colder the colour. A zero probability of belonging to the prostate is thus symbolised by giving the associated voxel the colour black and a certain probability of belonging to the prostate is thus symbolised by giving the associated voxel the colour red.

Given that certain voxels of the probability map CP may have a zero probability of belonging to the prostate (in particular, the voxels internal to the prostate, remembering that, in this case, all of the voxels of the image IP are involved in the first segmentation step), this may cause the probability map CP not to have entirely closed contours.

The computer system then executes an algorithm for filtering the voxels of the probability map in order to select, during a selection operation T′, n target points for which a high degree of certainty of belonging to the contour has been assigned (i.e., there is a high p(x,y,z) probability). For example, as for the first implementation, after having defined a fixed general threshold c for the probability of belonging (this general threshold c being pre-defined), corresponding to an acceptable probability of belonging, the computer system executes an algorithm for filtering the voxels of the probability map to select, during a selection operation T, n target points each corresponding to a position voxel x, y, z having a probability p(x,y,z) greater than the fixed general threshold c.

The inventors have been able to observe that the difficulty of the segmentation task varies greatly from one image to another. This is why the use of a single fixed general threshold typically has the effect of over-segmenting or under-segmenting the contour of the organs.

For this reason, the filtering algorithm preferably performs a second filtering of the filtered voxels, with a second threshold different from the first. As already indicated, the second filtering is also applicable to the first implementation, such that the following is indeed applicable to the first implementation.

The second threshold is a dynamic threshold, i.e., a threshold specific to the image in question.

The second threshold is optionally local, i.e., it is applied to only a portion of the probability map CP in question or its value depends on the zone of the probability map CP to which it is applied, in contrast to a general threshold which has the same value over the entire probability map CP. For example, since the anterior part of the prostate is more difficult to segment than the posterior part of the prostate, the second threshold may have a lower value when applied in the zone of the anterior part of the prostate than in the zone of the posterior part of the prostate.

The value of the second threshold is therefore adapted automatically (to each new probability map processed) and locally according to the considered zone(s) of a CP given probability map.

Depending on the application in question, this thresholding may exploit the gradient of the prediction to reject zones where the estimated contour is too diffuse or wide for the segmented zone to be considered anatomically correct.

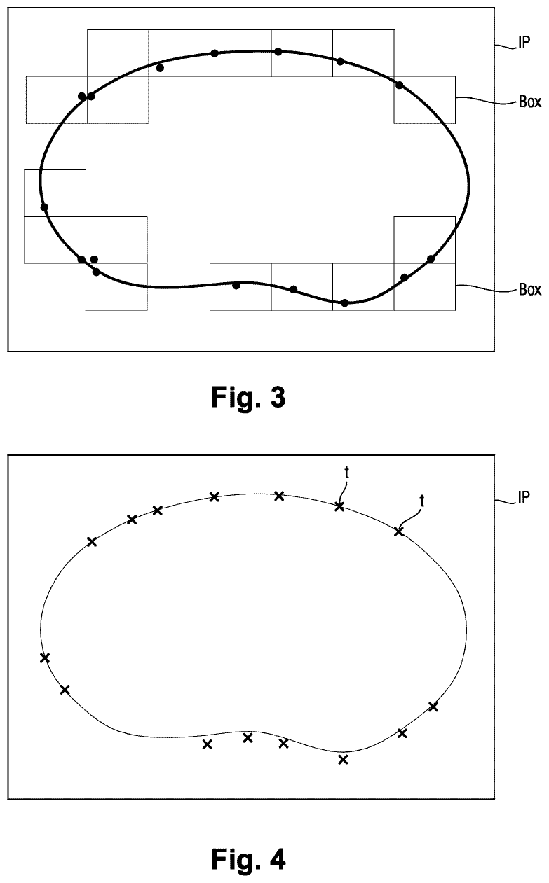

During this second filtering step (forming part of the selection operation T′), a reduced number of contour points will be searched for, for example, associated with local maxima of the probability of the organ contour being present at these positions (FIG. 3 illustrates these local maxima).

In practice, the program executed by the computer system proceeds as follows. The image IP associated with the probability map CP is broken down D into cases (also called boxes) and, for example, into boxes of identical dimensions and, for example, into rectangular parallelepipeds or cubes. Optionally, each box has dimensions Rx, Ry, Rz with a resolution of Rx=Ry=Rz and, for example, Rx=Ry=Rz=a with a of between 3 and 6 millimetres and, for example, between 5 and 5.5 millimetres.

The probability map in question is said to have a local maximum in a given voxel Vmax when there is a vicinity of Vmax such that for any voxel in that vicinity, the associated probability is less than or equal to that of Vmax.

For a box, the maximum probability voxel Vmax within said box is thus selected, to finally extract it as a target point.

This process is repeated for a new box to extract a new target point, etc.

This process is stopped as soon as it is possible to obtain n target points. The number n (e.g., 100) is the number of target points which will be used to deform the model, this number being pre-defined. The number n is pre-defined by the manufacturer and/or by the practitioner.

Preferably, it is possible to take into account that there is an insufficient number of target points, for example, if the number of target points retained at the end of this second filtering is lower than a pre-defined minimum threshold (for example, by the manufacturer and/or the practitioner). The segmentation method is then interrupted to propose to the operator that the organ be segmented without benefiting from the method of the invention.

The selection operation T′ is thus a filtering operation on the probability map CP. As a result, only target points with a very high probability of belonging to the contour of the prostate in the image are retained IP.

It may thus be understood that the target points are three-dimensional.

It may thus be understood that at the end of the selection operation T′, a cluster of target points is obtained.

Depending on the image IP, the number of target points thus extracted may be high. Therefore, at the end of the selection operation T′, certain groups of target points may already locally design contours of a prostate (in the form of at least one continuous surface and/or at least one discontinuous surface formed by points). Nevertheless, since other voxels on the probability map CP have been discarded (because their probability p(x,y,z) of belonging to the prostate in the image IP was too low and below the threshold c), these contours are necessarily partial. Under no circumstances, at the end of the selection operation T′, is a representation obtained of a prostate whose contours would be entirely closed.

By considering that a sufficient number of target points have been obtained (for example, that n points have been obtained), the program begins the deformation operation A′ during which the Combined Anatomical Model Comb is applied to the image IP by deforming the Combined Anatomical Model Comb on the basis of the n target points retained at the end of the operation T′. It is understood that the combined anatomical model thus makes it possible to determine the contour of the prostate on the basis of the n target points.

For example, the Combined Anatomical Model Comb designs one or more continuous surfaces between target points adjacent to one another (by interpolating and/or connecting them) and completes said surfaces to design a closed contour of the prostate via the anatomical information that it contains.

The Combined Anatomical Model deforms Comb only on the basis of the target points.

The Combined Anatomical Model Comb thus makes it possible to close the partial contour(s) which were defined by the cluster of target points.

The deformation operation A′ may therefore be seen as a transformation step of the Combined Anatomical Model Comb on the cluster of target points.

The deformation of the Combined Anatomical Model Comb may be performed in a single phase or in several phases. For example, the Combined Anatomical Model Comb may be deformed by iteration. For example, at each iteration i:
each target point is matched with the nearest Combined Anatomical Model point Comb;
then the Combined Anatomical Model Comb is scaled (scaling means that the Combined Anatomical Model Comb as a whole is enlarged or narrowed to better correspond to the target points—this scaling being particularly interesting for a patient whose organ in question is of a much larger or much smaller size than the average and therefore for whom the organ in question is of a much larger or much smaller size than the Combined Anatomical Model Comb) and generally deformed via an affine transformation based on the distance between each target point in question and the point of the Combined Anatomical Model Comb that has been matched to it (for example, the transformation is determined so as to minimise the sum of said distances and/or, for example, the transformation is calculated with the Arun algorithm);
then the Combined Anatomical Model Comb is elastically deformed, under the action of external forces deforming the Combined Anatomical Model Comb towards the target points and internal forces ensuring the regularity of the surface of the Combined Anatomical Model Comb (an elastic deformation being well known in the prior art, it will not be detailed further, it being understood that the external forces are obtained based on the distance between each target point in question and the point of the Combined Anatomical Model Comb that has matched it and the internal forces are obtained based on the Combined Anatomical Model Comb before deformation and/or on a constraint to have a smooth deformed contour, the deformation being based on the sum of these external and internal forces to deduce a movement of each of the vertices of the Combined Anatomical Model Comb).

Iterations i are stopped when the distances between the target points and the corresponding matched points of the Combined Anatomical Model Comb are (for at least some of the target points and preferably for all of the target points) lower than a pre-determined threshold.

This iterative approach, successively affine then elastic, allows the elastic deformations to gradually correct the errors of the previous affine transformation, and vice-versa.

An extrapolation of the contour from the Combined Anatomical Model is thus performed Comb.

This iterative approach is particularly interesting in places where the Combined Anatomical Model Comb is very far from a target point or a grouping of target points and/or in places where there are few target points.

This iterative approach makes it possible to generate an extrapolation of the contour of very good quality on the basis of the Combined Anatomical Model Comb even in places where the Combined Anatomical Model Comb is very far from a target point or a grouping of target points and/or in places where there are few target points.

This iterative approach is particularly interesting in places where the Combined Anatomical Model Comb is very far from a target point or a grouping of target points. Indeed, the Combined Anatomical Model Comb MA is thus deformed by iteration and in a localised way to reach this or these target point(s) and/or the zone comprising this or these target point(s). This localised deformation is preferably of the same order of magnitude as the localised deformation performed at the locations where the Combined Anatomical Model Comb is close to a target point or grouping of target points and is deformed in view of this target point or these target points.

This then produces the segmentation S_{IP}′ of the image IP.

Preferably, the deformation operation A takes into account at least one mesh coherence constraint during the deformation of the Combined Anatomical Model Comb: preventing the creation of a fold in the mesh, applying an elastic deformation or liquid mechanics constraint during the propagation of the deformation, etc.

Optionally, at each iteration i and via Arun's algorithm, an affine scaling transformation is extracted during the elastic deformation MA, of the Anatomical Model. For example, the elastic deformation field used during the elastic deformation is broken down by using Arun's algorithm into an affine component and a non-linear residual deformation. It is then possible to use this affine component to scale said model during the next iteration i+1. This allows for consistent general deformation during i+1 iteration even in zones not covered by target points.

Optionally, at least one of the internal forces is defined on the basis of at least one statistical study on the shape of the prostate (study identical to or different from that which has led to the creation of the Anatomical Model MA). An internal force thus makes it possible to further limit the risk of obtaining an

$${S}_{IP}^{′}$$

anatomically improbable segmentation.

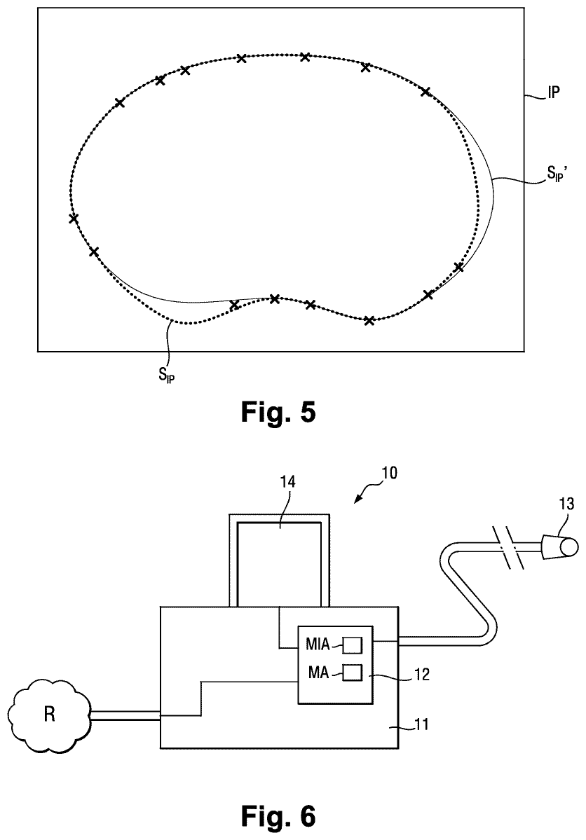

FIG. 5 shows the segmentation

$${S}_{IP}^{′}$$

obtained using the Combined Anatomical Model Comb and the segmentation S_{IP} that would have been obtained using only the Anatomical Model MA.

Optionally, the computer program preferably performs an automatic comparison of the segmentation S_{IP} (in the case of the first implementation), or of the segmentation

$${S}_{IP}^{′}$$

(in the case of the second implementation), with the older segmentation

$${S}_{IP}^{old} .$$

Such a comparison (for example, on the basis of the Dice coefficient or the volume difference) makes it possible to warn the practitioner when both segmentations of the same organ are not coherent with one another.

For both implementations, provision can be made for the program to allow a modulation of the influence of the prediction from the artificial intelligence model in deforming the anatomical model by varying the selectivity of the filtering process described above. By using a cursor, a box with a value to be completed (for example, by a percentage) or a tick-box displayed on the screen 14, the practitioner may adjust, in the segmentation obtained, the share of information predicted by the neural network and that completed by the anatomical model. If required, the practitioner may therefore, in particular, use only the deformable anatomical model.

In a clinical routine, the practitioner may accept or reject the segmentation proposed automatically by the method of the invention regardless of the implementation in question. The computer program thus provides the practitioner with the possibility of modifying the segmentation proposed by the method, as follows:
adding target points manually regardless of the number of target points selected by the method of the invention;
removing target points selected by the method of the invention.

The anatomical model is then then distorted towards these target points.

The description above relates to a method for segmenting an image in three dimensions. The segmentation of the image makes it possible to obtain a contour that can be used to perform, for example, image merging or operational planning.

Naturally, the invention is not limited to the described embodiments, but covers any variant coming within the scope of the invention as defined by the claims.

In particular, it is possible to combine all or part of both methods.

For example, double threshold filtering and/or the use of an old segmentation and/or the described algorithm comprising the steps of decomposing the probability map into a box and searching for one Vmax for at least one of the boxes, may be introduced in the first implementation.

Regardless of the implementation in question, the filtering may be general or local. Regardless of the implementation in question, the filtering may be fixed or dynamic.

If the filtering is dynamic, it will be possible to adapt the filtering such that, for at least one first zone of the probability map, the value of the threshold depends on the value of at least one threshold of at least one second zone of the probability map adjacent to the first.

It is possible to have a dynamic and general filtering and/or a fixed and local filtering and/or a fixed and general filtering and/or a dynamic and local threshold.

The examination device may be different from that described by the technology used (MRI instead of ultrasound, for example) or by the arrangement and/or choice of its components. The value of at least one threshold may be modulated manually, for example, by the practitioner.

The segmentation method may be based on a model other than the MIA to establish the probability map. For example, in place of the MIA, the method may be based on an at least partially-automatic segmentation method other than that of being based on the model MIA and, for example, any at least partially-automatic segmentation method capable of generating localised information on the reliability of its result.

In general, each of the steps of the method of the invention may be automatic or only partially-automatic.

Although, in this case, the statistical shape model has an average shape that is the average of the shapes of the same organ among a set of patients not including the patient in question, the statistical shape model may have an average shape that is the average of the shapes of the same organ among a set of patients including the patient in question.

Similarly, artificial intelligence may be trained using images of the same organ in a set of patients including or not the patient in question.

The model MA and/or the model MIA and/or the three-dimensional image to be segmented may be designed using a statistical processing of segmented images whose imaging modality differs from that of ultrasound and, for example, by MRI technology (sequence T1 and/or sequence T2 and/or sequence DC and/or sequence ADC, etc.), by scanner technology (such as PET Scan), etc.

Although, in this case, each image N and/or each image K is segmented manually during the pre-intervention phase, this segmentation may be performed differently. For example, for at least one image N and/or at least one image K, the segmentation may be automatic or partly automatic (for example, the segmentation is performed automatically and controlled and then adjusted by a human).

Although, in this case, the image bank used to produce the Artificial Intelligence Model is different from the Anatomical Model, the Artificial Intelligence Model may be established on the basis of at least one image bank used to establish the Anatomical Model.

The K images may be images captured with a different technology from that used for acquiring the images which will have to be segmented subsequently as MRI technology.

The N images may be images captured with the same technology as that used for acquiring the images which will have to be segmented subsequently.

In a prior step, the practitioner may manually place target points on the contour of the organ present in the image displayed on the screen 14 to initialise the placement of the anatomical model and the evolution of the closest neighbours of the latter towards these points indicated. This initialisation may be automated.

Preferably, the target points used to initialise the placement of the deformable model will be different from those used by the present invention to deform the deformable model.

The deformable model may have an initial shape defined by the shape of several organs (for example, the average of said shapes) and/or by the shape of a single organ (and for example, that of the patient obtained during a previous examination) and/or by an analytical shape (for example, designed by a practitioner or any other expert) and/or by a combination of said shapes specified above. When the deformable model is linked to shapes of several organs, it will therefore be referred to as a “statistical deformable shape model”. To define the deformable model, the shape of the patient's organ may be included or excluded. To create the “deformable statistical shape model”, it is also possible to include only the patient's organ (whose shape varies from one image to another, for example).

For the two embodiments described above, the method may comprise one or more additional steps.

For example, the method may comprise an additional step of pre-deforming the anatomical model followed by the actual deformation step described above. For example, during the pre-deformation step, the anatomical model may be roughly deformed to quickly obtain a first deformation. The pre-deformation step is thus robust. Then, during the actual deformation, the anatomical model will continue to be deformed more precisely, as proposed above.

Optionally, a first group of target points is thus extracted from the probability map by applying to the probability map at least one first threshold for the probability of belonging to the contour of the organ in the image. This first threshold is then relatively unselective in order to be able to create a first group containing a large number of target points. The anatomical model is then pre-deformed by using these target points. For example, the anatomical model is deformed so as to be aligned with the different target points of the first group, each target point being matched with the point of the closest anatomical model. This alignment is, for example, performed using Arun's algorithm.

Then, a second group of target points is extracted from the first group of target points by applying at least one second threshold for the probability of belonging to the contour of the organ on the image to the first group. This second threshold is more selective than the first threshold. This second threshold is thus defined so as to retain the points having a high probability of belonging to the contour. The configuration described relative to both embodiments is available, and thus the actual deformation step described above (relative to both embodiments) may be performed on the basis of this second group of target points. This deformation is thus more local and precise.

For example, the method comprises an additional step of automatically estimating the quality of the segmentation obtained. For example, such a step may make it possible to provide an indicator of reliability of the result obtained to the operator and, for example, a quality score Q. For example, when Q is below a first pre-determined threshold, the segmentation obtained S_{IP} or

$${S}_{IP}^{′}$$

is automatically discarded and/or when Q is between this first pre-determined threshold and a second pre-determined threshold, the operator is automatically warned that the quality of the segmentation obtained is questionable. For example, Q is calculated by evaluating the spatial correlation between the probability map CP and the segmentation obtained S_{IP} or

$${S}_{IP}^{′} .$$

For example, an automatic estimation of the quality of the segmentation S_{IP} or

$${S}_{IP}^{′}$$

is performed by calculating a quality score Q such as: Q=Q₀+α×r with
r the Pearson correlation coefficient, and
Q₀ and α estimated by a linear regression model, where the explained variable is the Dice coefficient between the segmentation S_{Ip} or

$${S}_{IP}^{′}$$

and a manually obtained segmentation, and the explanatory variable is this correlation r.

The Pearson correlation coefficient r is optionally calculated between the probability map CP and an ideal probability map [symbol] obtained from the final segmentation S_{IP} or

$${S}_{IP}^{′} .$$

This ideal probability map [symbol] , very strongly correlated with the final segmentation S_{Ip} or S_{Ip}′, that it is derived from, is the same size as the probability map CP. It allows the Pearson correlation coefficient r to be calculated (representative of the spatial correlation between the probability map CP and the ideal probability map [symbol] ) without having to binarise the probability map CP with an arbitrary threshold that would cause information to be lost. The ideal probability map [symbol] is calculated from the following formula:

$$p ( i ) = 1 - \frac{δ ( i , j )}{{δ}_{max}}$$

where p(i) is a probability value of a voxel i of the ideal probability map [symbol] and δ(i,j) is the Euclidean distance between the point associated with the voxel i (usually the centre of said voxel) and the point associated with the voxel j (usually the centre of said voxel) that is the contour point of S_{IP} or S_{IP}′ closest to the point associated with the voxel i. The distance δ(i,j) is normalised by the maximum Euclidean distance δₘₐₓ of the voxels of this probability map [symbol] .

1. A method for segmenting a three-dimensional image of at least one organ of a patient, comprising at least the steps of:
extracting from the three-dimensional image of the organ a probability map which assigns to each voxel of the image a probability of belonging to a contour of the organ on the image;
extracting from the probability map at least one target point based on the probability of belonging to the contour of the organ on the image, each target point being extracted from the probability map by applying to the probability map at least one threshold for the probability of belonging to the contour of the organ on the image;
and based on each target point extracted in the preceding step, deforming a deformable model of this organ in order to obtain the three-dimensional segmentation of the organ on the image.

2. The method according to claim 1, wherein the probability map is extracted by means of a model distinct from the deformable model.

3. The method according to claim 2, wherein the distinct model is defined by an at least partially-automatic segmentation method.

4. The method according to claim 3, wherein the distinct model is defined by at least one artificial intelligence trained from segmented images of the organ of at least other persons.

5. The module according to claim 1, wherein the at least one threshold is either general or local.

6. The method according to claim 1, wherein the at least one threshold has a value independent of, or dependent on, the organ and/or the patient and/or the three-dimensional image and/or the probability map.

7. The method according to claim 1, wherein the at least one threshold is dynamic.

8. The method according to claim 7, wherein the at least one dynamic threshold is a local threshold making it possible to select only local probability maxima of the probability map.

9. The method according to claim 1, wherein the deformable model is a statistical model of the shape of the organ to be segmented.

10. The method according to claim 1, wherein the shape of the deformable model is initially defined on the basis of the average of the shapes of the same organ in question but of other patients than the patient in question.

11. The method according to claim 1, wherein the initial shape of the deformable model is determined by imaging technology other than ultrasound.

12. The method according to claim 1, wherein the deformable model has an initial shape combined with a segmentation of the same organ in question of the same patient, obtained from an image acquired prior to acquiring the image currently being segmented.

13. The method according to claim 1, wherein:
from each target point extracted from the probability map, the deformable model is pre-deformed;
then only some of the target points extracted from the probability map are selected to form a sub-group of target points having a higher probability of belonging to the contour of the organ on the image than the target points not belonging to the sub-group;
from each target point of the sub-group, the deformable model is deformed.

14. The method according to claim 1, wherein the deformation of the deformable model is performed iteratively by alternating at least a scaling phase with an elastic deformation phase.

15. The method according to claim 14, wherein during the scaling phase a general deformable procedure is also performed, and wherein at each iteration, an elastic deformation field resulting from the elastic deformation is broken down into an affine component and a non-linear residual deformation, the affine component being used for the general deformation during the next iteration.

16. The method according to claim 1, wherein the quality of the segmentation obtained is estimated, by evaluating a spatial correlation between the probability map and said segmentation.

17. The method according to claim 1, wherein if the number of target points is less than a pre-determined threshold, the method is interrupted.

18. An installation comprising at least one image acquisition device and means for segmenting at least one image acquired by said device in accordance with the method, according to claim 1.

19. A computer program comprising instructions which, when executed by a processor, carries out the method according to claim 1.

20. A storage media which may be read by a computer, on which the computer program according to claim 19 is stored.
